(19) United States
(12) Patent Application Publication
(10) Pub. No.: US 2014/0224059 A1
(43) Pub. Date: Aug. 14, 2014

(54) STEERING WHEEL

(71) Applicant: TOYODA GOSEI CO., LTD., Kiyosu-shi (JP)

(72) Inventors: Bunpei MORITA, Kiyosu-shi (JP); Norio UMEMURA, Kiyosu-shi (JP)

(73) Assignee: TOYODA GOSEI CO., LTD., Kiyosu-shi (JP)

(21) Appl. No.: 14/168,287

(22) Filed: Jan. 30, 2014

(30) Foreign Application Priority Data
Feb. 8, 2013 (JP) 2013-023396

(51) Int. Cl. B62D 1/06

(52) U.S. Cl. CPC B62D 1/065
USPC 74/558

(57) ABSTRACT

A steering wheel includes a rim part having a rim cored bar, a low thermal conductive member that covers the rim cored bar, a planar heating element that is attached to the low thermal conductive member, and a decorative member that covers the planar heating element. The low thermal conductive member includes recesses which have an arc-shaped cross section forming an arc shape in a plane including an axis of the steering wheel and are formed in multiple sites that are spaced apart from each other in the circumferential direction of an annular cross section of the steering wheel in a plane perpendicular to the axis of the steering wheel. The plurality of recesses are formed so that the end portions in the circumferential direction of the arc-shaped cross section are arranged linearly along the circumferential direction of the annular cross section.

### CROSS REFERENCE TO RELATED APPLICATION

This application is based on Japanese Patent Application No. 2013-023396 filed on Feb. 8, 2013, the contents of which are incorporated herein by reference.

### BACKGROUND OF THE INVENTION

1. Technical Field

The present invention relates to a steering wheel having a planar heating element incorporated in a rim part.

2. Background Art

When a vehicle is parked at an extremely cold place, for example, in winter, the temperature inside the vehicle is lowered and therefore the temperature of a rim part (also referred to as “a handle part” or “a ring part”) of a steering wheel is lowered. When a driver rides on the vehicle and starts to drive in such a state, the driver grips the cold rim part and therefore it is difficult for the driver to steer the vehicle.

Accordingly, a steering wheel having a heating element incorporated in a rim part has been variously suggested. For example, a rim part of a steering wheel disclosed in JP-A-2010-036840 includes a rim cored bar 51, a low thermal conductive member 52, a pair of planar heating elements 53 and a decorative member (not shown), as shown in FIG. 18. The rim cored bar 51 has an annular cross section forming an annular shape in a plane perpendicular to an axis of a steering shaft. The low thermal conductive member 52 is formed of a material having a thermal conductivity lower than the rim cored bar 51 and covers the rim cored bar 51. Both planar heating elements 53 are attached to the low thermal conductive member 52 while surrounding the low thermal conductive member 52 and generate heat upon energization. The decorative member is formed, for example, of a real wood and covers the planar heating elements 53.

In the above-described steering wheel, the transfer of the heat generated from the planar heating elements 53 to the rim cored bar 51 is suppressed by the low thermal conductive member 52. As a result, heat loss is reduced and more heat is transferred to the decorative member whereby the temperature of the decorative member is effectively increased.

In JP-A-2010-036840, a plurality of recesses 54 is formed on the low thermal conductive member 52 in order to achieve a further reduction of heat loss. Each recess 54 has a C-shaped cross section forming a substantially annular shape in a plane including an axis of a steering shaft. The plurality of recesses 54 are formed at multiple sites that are spaced apart from each other in a circumferential direction of the annular cross section. With theses recesses 54, an air layer having a heat insulating effect is formed between the rim cored bar 51 and the planar heating elements 53. Further, the low thermal conductive member 52 is not brought into contact with the planar heating elements 53 at the sites where the recesses 54 are provided. As a result, the contact area between the planar heating elements 53 and the low thermal conductive member 52 is reduced, as compared to a case where the recesses 54 are not provided. The transfer of the heat generated from the planar heating elements 53 to the rim cored bar 51 through the low thermal conductive member 52 is further suppressed. As a result, more heat generated from the planar heating elements 53 is transferred to the decorative member and therefore the temperature of the decorative member is effectively increased.

Although not disclosed directly in JP-A-2010-036840, in the above-described steering wheel, it is considered that the following operations are performed in order to attach the planar heating elements 53 to the low thermal conductive member.

Adhesive (or gluing agent) is applied on an outer peripheral surface of the site of the low thermal conductive member 52 on which the recesses 54 are not provided. The planar heating elements 53 are adhered to the outer peripheral surface of the low thermal conductive member 52 while being deformed along the shape of the low thermal conductive member 52.

However, as described above, the plurality of recesses 54 has a C-shaped cross section forming a substantially annular shape in a plane including an axis of a steering shaft. Similarly, the outer peripheral surface of the site of the low thermal conductive member 52 on which the recesses 54 are not provided also forms a substantially annular shape in a plane including an axis of a steering shaft. These recesses 54 and the outer peripheral surface are not especially provided with a marker serving as a reference when attaching the planar heating elements 53. Therefore, it is difficult to place the planar heating elements 53 in a state of being positioned relative to the low thermal conductive member 52. As a result, it is difficult to accurately attach the planar heating elements 53 to a determined portion of the outer peripheral surface in the site of the low thermal conductive member 52 on which the recesses 54 are not provided.

The present invention has been made in consideration of the above-described situations and an object thereof is to provide a steering wheel in which a planar heating element can be easily positioned relative to a low thermal conductive member.

### SUMMARY

[1] A steering wheel includes a rim part that includes a rim cored bar that is a skeletal portion of the rim part, a low thermal conductive member that is formed of a material having a thermal conductivity lower than the rim cored bar and covers the rim cored bar, a planar heating element that is attached to the low thermal conductive member in a state of surrounding the low thermal conductive member, and a decorative member that covers the planar heating element. The low thermal conductive member includes recesses which have an arc-shaped cross section forming an arc shape in a plane including an axis of the steering wheel and are formed in multiple sites that are spaced apart from each other in the circumferential direction of an annular cross section of the steering wheel in a plane perpendicular to the axis of the steering wheel. The plurality of recesses are formed so that the end portions in the circumferential direction of the arc-shaped cross section are arranged linearly along the circumferential direction of the annular cross section.

In the steering wheel with the above configuration [1], some of heat is transferred to the decorative member on the outside of the planar heating element when the planar heating element generates heat. Further, some of the heat generated from the planar heating element is also transferred to the rim cored bar on the inside of the planar heating element. However, since the rim cored bar is covered with the low thermal conductive member having a thermal conductivity lower than the rim cored bar, the heat is not easily transferred to the rim cored bar, as compared to a case where the rim cored bar is not covered. Furthermore, since air inside the recesses provided on the low thermal conductive member exhibits a heat insulating effect, a phenomenon that the heat generated from the planar heating element is transferred to the rim cored bar through the low thermal conductive member is suppressed by the recesses.

Therefore, even when the temperature of the decorative member configuring an outer surface of the rim part is low before a driver starts to drive vehicular things such as a vehicle, for example, the heat generated from the planar heating element is efficiently transferred to the decorative member and therefore it is possible to heat the decorative member, at an early stage, up to a temperature at which the driver can easily grip the decorative member.

However, in the above-described steering wheel, the end portions of each recess that are arranged linearly along a circumferential direction of the annular cross section can be used as a reference when carrying out positioning on a circumferential direction of the arc-shaped cross section. Therefore, upon attaching the planar heating element to the low thermal conductive member, positioning of the planar heating element relative to the low thermal conductive member can be carried out by using the end portions of each recess as a reference. For example, in a case where the planar heating element is disposed in the normal position of the low thermal conductive member, the sites of the planar heating element corresponding to the end portions of the recesses are set in advance. In this manner, the planar heating element is positioned in the circumferential direction of the arc-shaped cross section by matching the sites with the end portions of the recesses. In a state of being positioned, the planar heating element is disposed around the low thermal conductive member so as to surround the low thermal conductive member whereby the planar heating element is disposed in the normal position of the low thermal conductive member.

[2] In the steering wheel of [1], the recesses are first recesses and the arc-shaped cross section is a first arc-shaped cross section, the low thermal conductive member further includes second recesses that are arranged to be opposed to the first recesses across the rim cored bar in the plane including the axis and has a second arc-shaped cross section forming an arc shape, the plurality of second recesses are formed so that the end portions in the circumferential direction of the second arc-shaped cross section are arranged linearly along the circumferential direction of the annular cross section, and convex surface portions are formed between adjacent end portions of the first recesses and the second recesses in the circumferential direction of the first arc-shaped cross section and the second arc-shaped cross section.

According to the above configurations [1] or [2], the air inside the first recesses and the air inside the second recesses, which are provided on the low thermal conductive member, exhibit a heat insulating effect. Therefore, a phenomenon that the heat generated from the planar heating element is transferred to the rim cored bar through the low thermal conductive member is suppressed by the air inside the first recesses and the air inside the second recesses. This effect of suppressing the heat transfer is greater than when the second recesses are not provided.

Further, the convex surface portions formed between adjacent end portions of the first recesses and the second recesses in the circumferential direction of the first arc-shaped cross section and the second arc-shaped cross section are in contact with the planar heating element. With this contact, the planar heating element is prevented from entering into the first recesses and the second recesses.

[3] In the steering wheel of [2], the convex surface portions form part of an outer peripheral surface of the low thermal conductive member, and the planar heating element is attached to the low thermal conductive member by being adhered to the outer peripheral surface of the low thermal conductive member.

According to the above configurations [1] to [3], the planar heating element is attached to the low thermal conductive member by being adhered to an outer peripheral surface of the low thermal conductive member. The outer peripheral surface includes the convex surface portions. Accordingly, the planar heating element is adhered to the low thermal conductive member over a wide surface by the size of these convex surface portions whereby the adhering operation can be easily performed.

[4] In the steering wheel of [1], the recesses are first recesses and the arc-shaped cross section is a first arc-shaped cross section, the low thermal conductive member further includes second recesses that are arranged to be opposed to the first recesses across the rim cored bar in a plane including the axis and passing through between the first recesses adjacent in the circumferential direction of the annular cross section and has a second arc-shaped cross section forming an arc shape, and the second recesses are formed so that the end portions in the circumferential direction of the second arc-shaped cross section are arranged collinear with the line on which the end portions of the first recesses are arranged along the circumferential direction of the annular cross section.

According to the above configurations, the air inside the first recesses and the air inside the second recesses, which are provided on the low thermal conductive member, exhibit a heat insulating effect. Therefore, a phenomenon that the heat generated from the planar heating element is transferred to the rim cored bar through the low thermal conductive member is suppressed by the air inside the first recesses and the air inside the second recesses. This effect of suppressing the heat transfer is greater than when the second recesses are not provided.

Further, since the end portions of the second recesses in the circumferential direction of the second arc-shaped cross section are arranged collinear with the line on which the end portions of the first recesses in the circumferential direction of the first arc-shaped cross section are arranged along the circumferential direction of the annular cross section, the end portions of the second recesses can be used as a reference when carrying out positioning on the circumferential direction of the first arc-shaped cross section and the second arc-shaped cross section. Therefore, upon attaching the planar heating element to the low thermal conductive member, positioning of the planar heating element relative to the low thermal conductive member can be carried out by using, as a reference, the end portions linearly and continuously arranged as described above.

According to the steering wheel, since the recesses are formed in the low thermal conductive member so that the end portions of the recesses in the circumferential direction of the arc-shaped cross section are arranged linearly along the circumferential direction of the annular cross section, positioning of the planar heating element relative to the low thermal conductive member can be easily carried out.

### BRIEF DESCRIPTION OF THE DRAWINGS

FIG. 1 shows a first embodiment of a steering wheel and is a side view of the steering wheel.

FIG. 2 is a view (front view) of the steering wheel shown in FIG. 1, as seen in a direction of an arrow A.

FIG. 3 is a sectional view showing an enlarged cross-sectional structure of a rim part, taken along a line 3-3 in FIG. 2.

FIG. 4 is a sectional view showing an enlarged cross-sectional structure of the rim part, taken along a line 4-4 in FIG. 2.

FIG. 5 is a partial perspective view showing the rim part of the first embodiment, a portion of which is cut out.

FIG. 6 is a partial sectional view showing a cross-sectional structure of the rim part, taken along a line 6-6 in FIG. 3.

FIG. 7 is a partial front view showing a state (a state of the rim part before a planar heating element and a decorative member are attached to a low thermal conductive member) of the steering wheel of the first embodiment in the middle of manufacturing.

FIG. 8 is a partial front view showing an enlarged portion of “P” in FIG. 7.

FIG. 9 is a partial plan view of the low thermal conductive member of the first embodiment.

FIG. 10 is a sectional view corresponding to FIG. 3, showing a state before the planar heating element is attached to the low thermal conductive member.

FIG. 11 is a sectional view corresponding to FIG. 3, showing a state before the planar heating element is covered with the decorative member.

FIG. 12 shows a second embodiment of a steering wheel and is a partial perspective view showing a rim part thereof, a portion of which is cut out.

FIG. 13 shows the second embodiment and is a sectional view showing the cross-sectional structure of the rim part at a site corresponding to FIG. 3.

FIG. 14 shows the second embodiment and is a sectional view showing the cross-sectional structure of the rim part at a site corresponding to FIG. 4.

FIG. 15 is a partial sectional view showing the cross-sectional structure of the rim part, taken along a line 15-15 in FIG. 13.

FIG. 16 shows the second embodiment and is a partial plan view of a low thermal conductive member, corresponding to FIG. 9.

FIG. 17 shows the second embodiment and is a sectional view corresponding to FIG. 10, showing a state before the planar heating element is attached to the low thermal conductive member.

FIG. 18 is a view explaining a conventional steering wheel and is a partial perspective view showing a state before the planar heating element is attached to the low thermal conductive member.

### DESCRIPTION OF PREFERRED EMBODIMENT

### First Embodiment

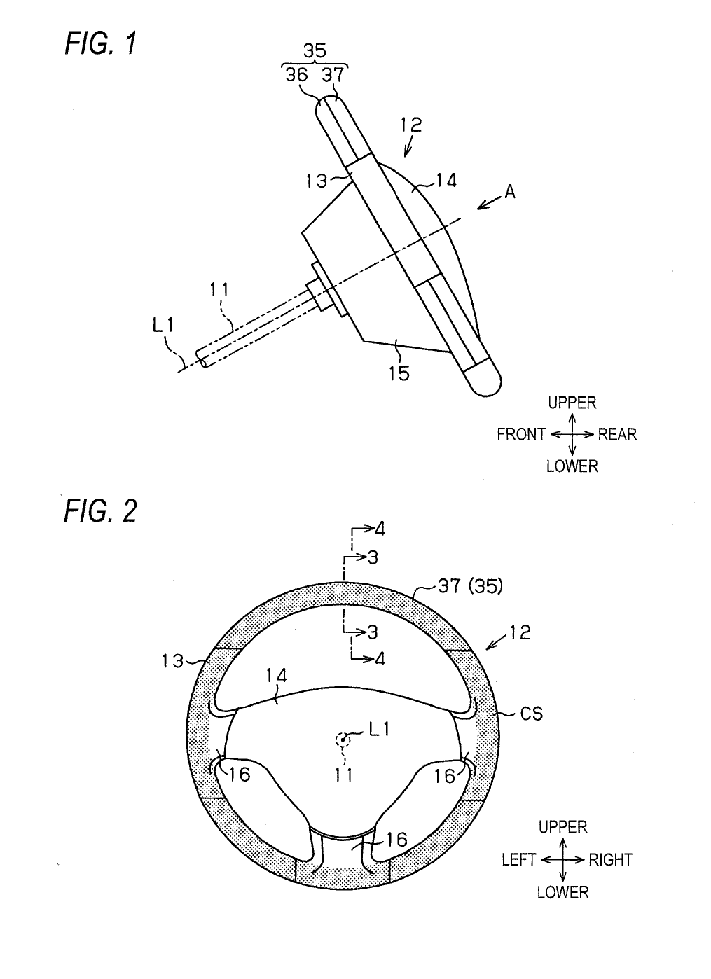

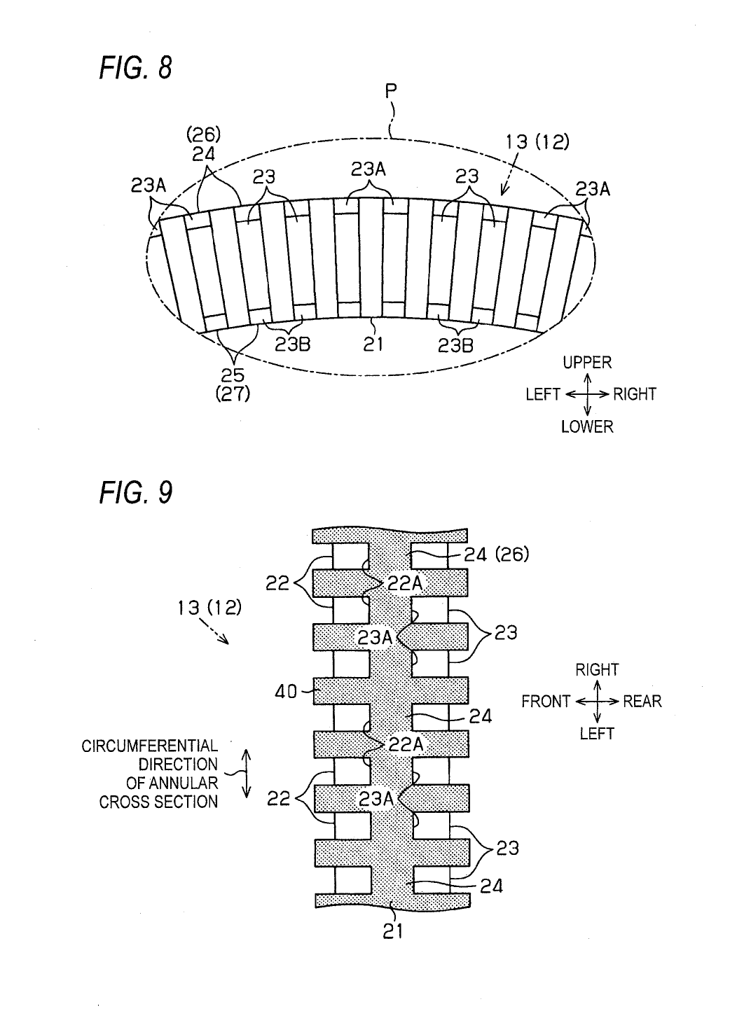

Hereinafter, a first embodiment of a steering wheel will be described with reference to FIG. 1 to FIG. 11.

As shown in FIG. 1 and FIG. 2, a steering shaft 11 is provided on a front side (left side in FIG. 1) of a driver's seat of a vehicle in an inclined state where the steering shaft 11 becomes higher toward the driver's seat side (right side in FIG. 1). The steering shaft 11 rotates about an axis L1. A steering wheel 12 is attached to a rear end portion of the steering shaft 11 so as to rotate integrally therewith.

The steering wheel 12 includes a rim part (also referred to as “a handle part” or “a ring part”) 13, a pad part 14 and a spoke part 16. The rim part 13 is a portion that is gripped by a driver and rotationally operated (steered). As indicated by the halftone (collection of fine points) in FIG. 2, the rim part 13 has an annular cross section CS forming a substantially ring shape in a plane perpendicular to the axis L1.

The pad part 14 is disposed in a space surrounded by the rim part 13. A front side portion of the pad part 14 is configured by a lower cover 15 (see FIG. 1). A plurality of (three in the present embodiment) spoke parts 16 are provided between the rim part 13 and the pad part 14.

In order to specify the position in the circumferential direction of the annular cross section CS of the rim part 13 that is rotationally operated (steered), in the first embodiment, “upper”, “lower” “left” and “right” are defined with reference to a state (neutral state) when a vehicle goes straight.

Cored bars formed of iron, aluminum, magnesium or alloy thereof or the like are disposed on the inside of each of the rim part 13, the spoke part 16 and the pad part 14 of the steering wheel 12. Among these cored bars, the cored bar located on the inside of the rim part 3 configures a skeletal portion of the rim part 13 and has a substantially ring shape, as seen from the driver side. This cored part is referred to as a rim cored bar 20.

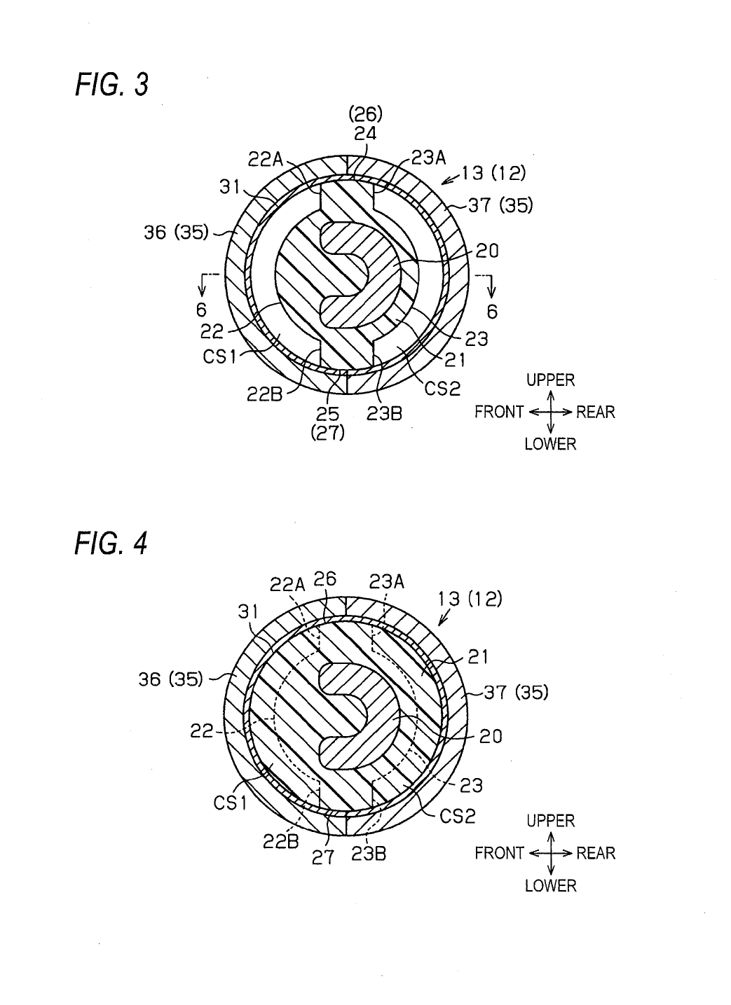

As shown in FIG. 3 and FIG. 4, the rim cored bar 20 is disposed at a site that is spaced apart inward from an outer surface of the rim part 13. Although the rim cored bar 20 has a substantially U-shaped cross-sectional shape in the present embodiment, the rim cored bar may have other cross-sectional shape.

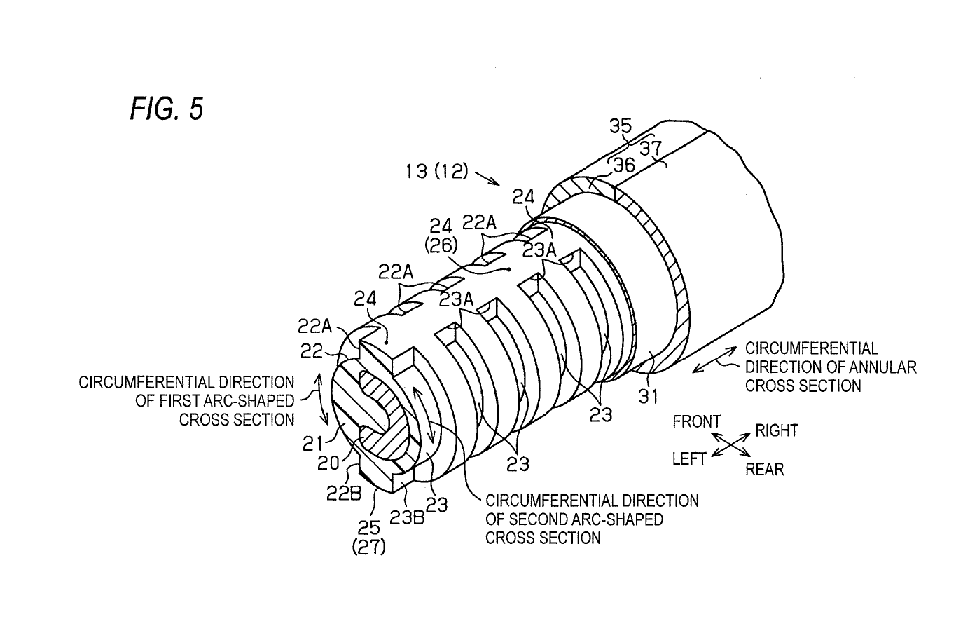

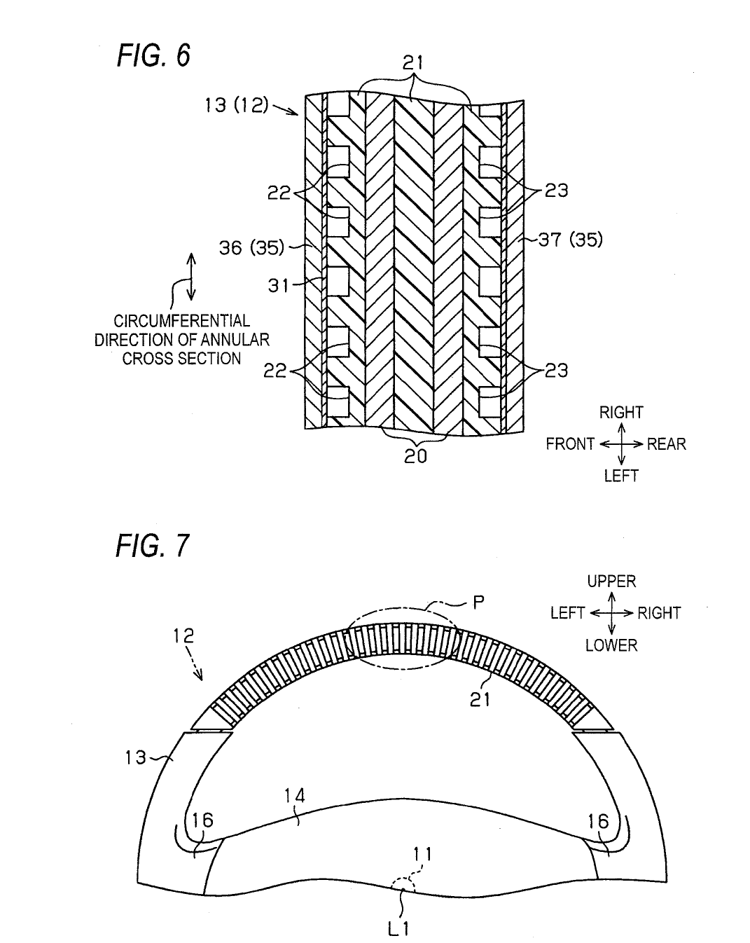

As shown in FIG. 5 and FIG. 6, a portion of the rim part 13 in the circumferential direction of the annular cross section CS has a structure different from the other portions thereof. In the first embodiment, at least an upper portion of the rim part 13 has the different structure (see FIG. 1 and FIG. 2).

In this portion, a low thermal conductive member 21, a planar heating element 31 and a decorative member 35 are provided in this order on the outside of the rim cored bar 20.

The low thermal conductive member 21 is formed in a state of covering the rim cored bar 20 by a resin molding method such as an injection molding method, using a resin material that is a material having a thermal conductivity lower than the rim cored bar 20. In the first embodiment, PP (Polypropylene) is employed as the resin material, the rim cored bar 20 is used as an insert and the low thermal conductive member 21 is formed integrally with the rim cored bar 20 while being in close contact with the periphery of the rim cored bar 20.

The planar heating element 31 includes a base fabric formed of a flexible material and a heating body disposed on the base fabric. In the present embodiment, the base fabric formed of non-woven fabric is used. The heating body is formed of, for example, a wire material (electric wire for heating: electric heating wire) that has a large electrical resistance and generates heats by energization. The heating body (electric heating wire) is arranged in a state of being repeatedly curved so as to from a waveform over substantially the entire surface of the base fabric and is engaged with the base fabric. The planar heating element 31 is attached to the low thermal conductive member 21 by being adhered to an outer peripheral surface of the low thermal conductive member 21 by adhesive or gluing agent in a state of surrounding the low thermal conductive member 21. The planar heating element 31 is not in direct contact with the rim cored bar 20.

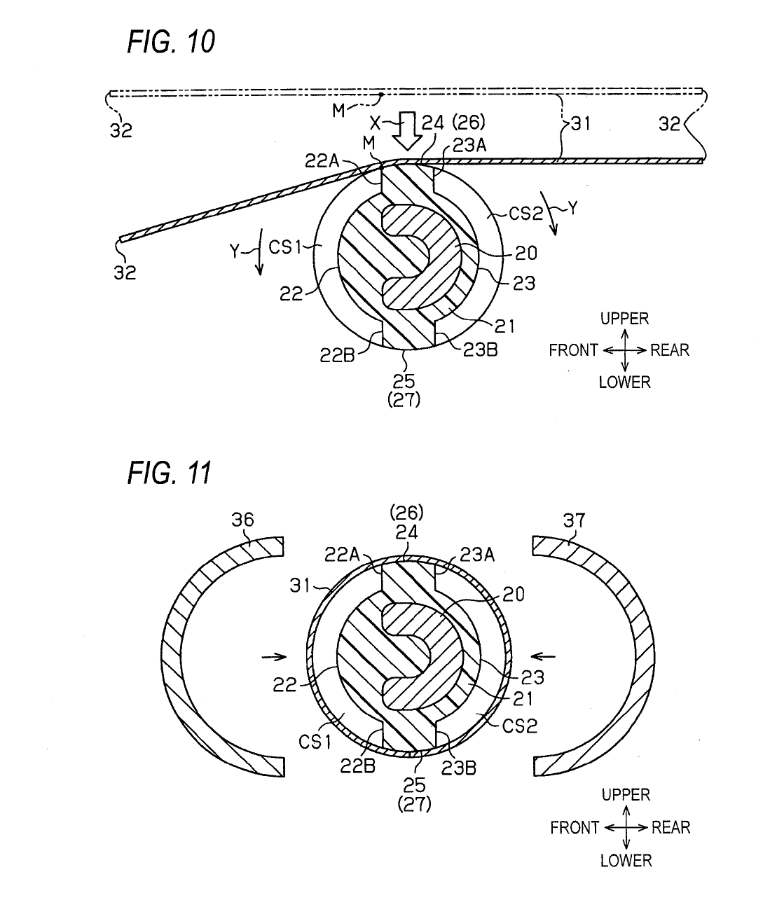

As indicated by two-dot chain line in FIG. 10, the planar heating element 31 in a state of being deployed to the planar shape has a rectangular shape that is elongated in a direction perpendicular to the paper surface than a lateral direction in FIG. 10. In the present embodiment, in order to specify the direction of the planar heating element 31 having such a rectangular shape, the lateral direction in FIG. 10 is defined as “a width direction” and the direction perpendicular to the paper surface in FIG. 10 is defined as “a longitudinal direction”.

The planar heating element 31 includes a pair of opposing edges 32 extending in a longitudinal direction in a state of being opposed to each other. The planar heating element 31 is formed with notched portions (not shown) extending from multiple sites of each of the opposing edges 32 toward the other opposing edge 32 side. These notched portions are intended for preventing wrinkles from entering into the planar heating element 31 when the planar heating element 31 is deformed along the low thermal conductive member 21.

As shown in FIG. 3 and FIG. 11, the decorative member 35 is configured by a pair of front and rear outer shell members 36, 37 to cover the planar heating element 31. Both outer shell members 36, 37 have a sufficient rigidity so as not to be deformed even when gripped by a driver. The front outer shell member 36 has a substantially semicircular arc-shaped cross section whose rear end is opened in a plane including the axis L1. Further, the rear outer shell member 37 has a substantially semicircular arc-shaped cross section whose front end is opened in the plane including the axis L1. Each of the outer shell members 36, 37 is formed of wood with the intention of improving the feeling and design (outer appearance) or the like of the rim part 13. Both the front and rear outer shell members 36, 37 are connected to each other in a state of covering the planar heating element 31.

Each of the outer shell members 36, 37 may be formed by a single plate of natural wood. Further, each of the outer shell members 36, 37 may be configured by a decorative sheet of natural wood and a lining material adhered to the decorative sheet from the inside. These outer shell members 36, 37 give a wood grain pattern to an outer surface of the rim part 13. A transparent coating film (not shown) is formed on the outer surface of the outer shell members 36, 37 by a clear painting.

As shown in FIG. 7 to FIG. 9, in the first embodiment, a member having a structure different from that of the prior art (see FIG. 18 in JP-A-2010-036840) is employed as the low thermal conductive member 21 that is one of the members to configure the rim part 13. Next, a structure of the low thermal conductive member 21 will be described.

The low thermal conductive member 21 of the first embodiment is provided with a plurality of first recesses 22. As shown in FIG. 3 and FIG. 5, these first recesses 22 have a first arc-shaped cross section CS1 forming a substantially semicircular arc shape in a plane including the axis L1. Further, the first recesses 22 are formed at regular intervals in multiple sites that are spaced apart from each other in the circumferential direction of the annular cross section CS. The plurality of first recesses 22 are formed in such a way that respective end portions 22A, 22B in the circumferential direction of the first arc-shaped cross section CS1 are arranged linearly and intermittently along the circumferential direction of the annular cross section CS.

Further, second recesses 23 are provided in the sites that are located in the plane including the axis L1 and opposed to each of the first recesses 22 across the rim cored bar 20 and have a second arc-shaped cross section CS2 forming a substantially semicircular arc shape. The second recesses 23 are formed at regular intervals in multiple sites that are spaced apart from each other in the circumferential direction of the annular cross section CS. The plurality of second recesses 23 are formed in such a way that respective end portions 23A, 23B in the circumferential direction of the second arc-shaped cross section CS2 are arranged linearly and intermittently along the circumferential direction of the annular cross section CS.

Convex surface portions 24 are formed between the adjacent end portions 22A, 23A of the first recesses 22 and the second recesses 23 in the circumferential direction of the first arc-shaped cross section CS1 and the second arc-shaped cross section CS2. Further, convex surface portions 25 are formed between the adjacent end portions 22B, 23B of the first recesses 22 and the second recesses 23 in the circumferential direction. A plurality of convex surface portions 24 is arranged linearly and intermittently along the circumferential direction of the annular cross section CS and configures a portion of a strip-like portion 26 extending in the circumferential direction of the annular cross section CS and having a predetermined width. Similarly, a plurality of convex surface portions 25 is arranged linearly and intermittently along the circumferential direction of the annular cross section CS and configures a portion of a strip-like portion 27 extending in the circumferential direction of the annular cross section CS and having a predetermined width. Both strip-like portions 26, 27 are located in two sites that are opposed to each other across the rim cored bar 20. One strip-like portion 26 of them is formed in a site or its vicinity where the diameter of the annular cross section CS is maximized. In order words, one strip-like portion 26 is formed in an outer peripheral portion of the low thermal conductive member 21. Further, the other strip-like portion 27 of them is formed in a site or its vicinity where the diameter of the annular cross section CS is minimized. In order words, the other strip-like portion 27 is formed in an inner peripheral portion of the low thermal conductive member 21.

Both of the convex surface portions 24 (strip-like portion 26) and the convex surface portions 25 (strip-like portion 27) configure a portion of the outer peripheral surface of the low thermal conductive member 21. Then, the planar heating element 31 is adhered to the outer peripheral surface of the low thermal conductive member 21 including both convex surface portions 24, 25 (strip-like portions 26, 27).

Next, an operation of the steering wheel 12 of the first embodiment configured as described above will be described.

Initially, an operation of attaching the planar heating element 31 to the low thermal conductive member 21 will be described. This operation is performed in a state where the rim cored bar 20 including the low thermal conductive member 21 is erected (the axis L1 is horizontal) and the attached portions of the low thermal conductive member 21 to be attached with the planar heating element 31 are located on the top of the rim cored bar 20.

First, as indicated by the halftone in FIG. 9, on the attached portions of the low thermal conductive member 21 to be attached with the planar heating element 31, i.e., on the top of the rim cored bar 20 in the erected state, adhesive (gluing agent) 40 is applied to an outer peripheral surface of the sites of the low thermal conductive member 21 on which the first recesses 22 and the second recesses 23 are not provided. In the case of manual operation, the application operation is performed by using a brush, for example. The sites of the low thermal conductive member 21 to be applied with adhesive include an outer peripheral surface between the first recesses 22 adjacent in the circumferential direction of the annular cross section CS and an outer peripheral surface between the second recesses 23 adjacent in the circumferential direction. In addition to these surfaces, the convex surface portions 24 formed between the adjacent end portions 22A, 23A of the first recesses 22 and the second recesses 23 in the circumferential direction of the first arc-shaped cross section CS1 and the second arc-shaped cross section CS2 and the convex surface portions 25 formed between the adjacent end portions 22B, 23B of the first recesses 22 and the second recesses 23 in the circumferential direction are also included (see FIG. 10). In other words, a pair of strip-like portions 26, 27 is also included in the site to be applied with adhesive.

When the adhesive (or gluing agent) 40 is dried to some extent, the planar heating element 31 is adhered to the outer peripheral surfaces of the low thermal conductive member 21 while being deformed along the shape of the low thermal conductive member 21.

At this time, as shown in FIG. 18, a plurality of recesses 54 has a substantially ring-shaped cross section in a plane including an axis of a steering shaft. In JP-A-2010-036840, a mark serving as a reference when attaching the planar heating elements 53 is provided in neither the recesses 54 nor the outer peripheral surface of the sites of the low thermal conductive member 52 on which the recesses 54 are not provided. Therefore, it is difficult to place the planar heating elements 53 in a state of being positioned relative to the low thermal conductive member 52.

In this regard, in the first embodiment, as shown in FIG. 9 and FIG. 10, the end portions 22A of each first recess 22 or the end portions 23A of each second recess 23 which are arranged linearly and intermittently along the circumferential direction of the annular cross section CS can be used as a reference when carrying out positioning on the circumferential direction of the first arc-shaped cross section CS1 and the second arc-shaped cross section CS2. The end portions 22A, 23A serving as such a reference are located on the top of the rim cored bar 20 in the erected state.

Therefore, upon attaching the planar heating element 31 to the low thermal conductive member 21, positioning of the planar heating element 31 relative to the low thermal conductive member 21 is carried out by using the end portions 22A of each first recess 22 or the end portions 23A of each second recess 23 as a reference.

For example, in a case where the planar heating element 31 is disposed in the normal position of the low thermal conductive member 21, the sites of the planar heating element 31 which are located on the top of the rim cored bar 20 and correspond to the upper-side end portions 22A of the first recesses 22 are set in advance. Then, a mark M is attached to the site of the planar heating element 31. In the first embodiment, one-side end portions 22A of each first recess 22 in the circumferential direction of the first arc-shaped cross section CS 1 are located in near the site where the diameter of the annular cross section CS is maximized. For this reason, the mark M is attached to the substantially central portion in the width direction (lateral direction in FIG. 10) of the planar heating element 31.

As indicated by two-dot chain line in FIG. 10, the planar heating element 31 is placed on the top of the attached portions of the low thermal conductive member 21 so that the mark M is positioned on the top of the upper-side end portions 22A of each first recess 22. In such a state, when the planar heating element 31 is lowered as indicated by an arrow X in FIG. 10 and therefore the mark M matches the upper-side end portions 22A of the first recesses 22, the planar heating element 31 is in a state of being positioned in the circumferential direction of the first arc-shaped cross section CS1 and the second arc-shaped cross section CS2. A portion of the planar heating element 31, i.e., the portion of the planar heating element 31 near the mark M is adhered to near the site of the low thermal conductive member 21 where the diameter of the annular cross section CS is maximized.

Subsequently, the portions of the planar heating element 31 located on both sides of the marker M in the width direction thereof are respectively deformed downwardly along an outer peripheral surface of the low thermal conductive member 21, as indicated by an arrow Y in FIG. 10. In the course of this deformation, the planar heating element 31 is adhered to the outer peripheral-side strip-like portion 26 of the outer peripheral surface of the low thermal conductive member 21. Further, the planar heating element 31 is adhered to the outer peripheral surface between the first recesses 22 adjacent in the circumferential direction of the annular cross section CS and the outer peripheral surface between the second recesses 23 adjacent in the circumferential direction.

Eventually, at least one-side opposing edge 32 in a width direction of the planar heating element 31 is adhered to the inner peripheral-side strip-like portion 27 of the annular cross section CS.

In this way, the planar heating element 31 is disposed around the low thermal conductive member 21 so as to surround the low thermal conductive member 21. Accordingly, the planar heating element 31 is attached to the low thermal conductive member 21 in such a way that the planar heating element 31 is adhered to an outer peripheral surface of the low thermal conductive member 21 while being disposed in the normal position of the low thermal conductive member 21. The outer peripheral surface includes the convex surface portions 24, 25. Accordingly, the planar heating element 31 is adhered to the low thermal conductive member 21 over a wide surface by the size of these convex surface portions 24, 25.

Next, an operation of the steering wheel 12 in which the planar heating element 31 is attached to the low thermal conductive member 21, as described above, will be described.

In a case where driving of a vehicle is started under a situation that the outside air temperature is low in winter or the like and therefore the temperature of an outer surface of the rim part 13 is low, the planar heating element 31 (precisely, heating body (electric heating wire)) shown in FIG. 5 and FIG. 6 generates heat when the heating body of the planar heating element 31 is energized. Some of the heat generated from the planar heating element 31 is transferred to the decorative member 35 on the outside of the planar heating element 31. With this heat transfer, the temperature of the decorative member 35 is increased.

Further, some of the heat generated from the planar heating element 31 is transferred to the rim cored bar 20 on the inside of the planar heating element 31. Here, the rim cored bar 20 is formed of metal (including alloy) of the type described above and therefore has high thermal conductivity. For this reason, when the heat generated from the planar heating element 31 is transferred to the rim cored bar 20, the heat is likely to escape through the rim cored bar 20 (i.e., heat loss is likely to occur) and, correspondingly, the heat transferred to the decorative member 35 from the planar heating element 31 is reduced.

However, since the rim cored bar 20 is covered with the low thermal conductive member 21 having a thermal conductivity lower than the rim cored bar 20, the heat is less likely to be transferred to the rim cored bar 20 (i.e., heat loss is reduced), as compared to a case where the rim cored bar 20 is not covered with the low thermal conductive member 21 and at least a portion of the planar heating element 31 is in direct contact with the rim cored bar 20. Furthermore, air inside each of the first recesses 22 and air inside each of the second recesses 23 have a very low thermal conductivity and therefore exhibits a heat insulating effect. Therefore, a phenomenon that the heat generated from the planar heating element 31 is transferred to the rim cored bar 20 through the low thermal conductive member 21 is suppressed by the air inside each of the first recesses 22 and the air inside each of the second recesses 23. This effect of suppressing the heat transfer is greater than when either of the first recesses 22 and the second recesses 23 is not provided. As a result, more of the heat generated from the planar heating element 31 is transferred to the decorative member 35 and therefore the decorative member 35 is heated efficiently (at an early stage) up to a temperature at which a driver can easily grip the decorative member 35.

Further, assuming that the convex surface portions 24, 25 are not provided in the low thermal conductive member 21, the planar heating element 31 can easily enter into the first recesses 22 and the second recesses 23. When a portion of the planar heating element 31 enters into the first recesses 22 or the second recesses 23, the entered portion is away from the decorative member 35 and, correspondingly, the heat generated from the planar heating element 31 is less likely to reach the decorative member 35. In this regard, according to the first embodiment, the convex surface portions 24, 25 provided between the first recesses 22 and the second recesses 23 are in contact with the planar heating element 31 and therefore the movement of the planar heating element 31 toward the rim cored bar 20 is restricted. Accordingly, a portion of the planar heating element 31 is less likely to enter into the first recesses 22 or the second recesses 23. As a result, any part of the planar heating element 31 is not away from the decorative member 35.

According to the first embodiment described above in detail, the following effects are obtained.

(1) The low thermal conductive member 21 is provided with the first recesses 22 that have the first arc-shaped cross section CS1 forming a substantially semicircular arc shape in a plane including the axis L1 of the steering shaft 11 and are formed in multiple sites of the rim part 13 which are spaced apart from each other in the circumferential direction of the annular cross section CS in a plane perpendicular to the axis L1. Further, the plurality of first recesses 22 are formed in such a way that the end portions 22A, 22B in the circumferential direction of the first arc-shaped cross section CS1 are arranged linearly and intermittently along the circumferential direction of the annular cross section CS (see FIG. 3 to FIG. 5).

Therefore, the phenomenon that the heat generated from the planar heating element 31 is transferred to the rim cored bar 20 through the low thermal conductive member 21 can be suppressed by the heat insulating effect of the air inside the first recesses 22. In this way, the heat loss is reduced, so that more of the heat generated from the planar heating element 31 can be efficiently transferred to the decorative member 35.

Further, positioning of the planar heating element 31 in the circumferential direction of the first arc-shaped cross section CS1 can be simply carried out by using, as a reference, the end portions 22A of each first recess 22 which are arranged linearly and intermittently along the circumferential direction of the annular cross section CS. In addition, since the planar heating element 31 positioned as described above is disposed around the low thermal conductive member 21 so as to surround the low thermal conductive member 21, it is possible to place the planar heating element 31 in the normal position of the low thermal conductive member 21.

(2) The second recesses 23 are provided in the sites that are located in the plane including the axis L1 and opposed to the first recesses 22 across the rim cored bar 20 and have the second arc-shaped cross section CS2 forming a substantially semicircular arc shape. The plurality of second recesses 23 are formed in such a way that the end portions 23A, 23B in the circumferential direction of the second arc-shaped cross section CS2 are arranged linearly and intermittently along the circumferential direction of the annular cross section CS. The convex surface portions 24 are formed between the adjacent end portions 22A, 23A of the first recesses 22 and the second recesses 23 in the circumferential direction of the first arc-shaped cross section CS1 and the second arc-shaped cross section CS2 and the convex surface portions 25 are formed between the adjacent end portions 22B, 23B thereof (see FIG. 3 to FIG. 5).

Therefore, the phenomenon that the heat generated from the planar heating element 31 is transferred to the rim cored bar 20 through the low thermal conductive member 21 can be suppressed by the air inside the first recesses 22 and the air inside the second recesses 23. This effect of suppressing the heat transfer can be greater than when the second recesses 23 are not provided.

Further, the planar heating element 31 is prevented from entering into the first recesses 22 and the second recesses 23 by the convex surface portions 24, 25. With this prevention, the following effects can be expected.
When the planar heating element 31 enters into the first recesses 22 or the second recesses 23, the entered portion is away from the decorative member 35 and the amount of heat transferred to the decorative member 35 is reduced whereby there is a possibility that the heater performance is degraded. However, such a phenomenon is less likely to occur in the first embodiment.
In a case where the planar heating element 31 enters into the first recesses 22 or the second recesses 23, there is a possibility that the heating body (electric heating wire) of the planar heating element 31 is interfered with the sharp portion when boundary portions between the first and second recesses 22, 23 and the convex surface portions 24, 25 are sharp. However, such interference is less likely to occur in the first embodiment.
When the planar heating element 31 enters into the first recesses 22 or the second recesses 23, the effective length of the planar heating element 31 in the circumferential direction of the annular cross section CS is shortened and therefore the end portion of the planar heating element 31 in the same direction (longitudinal direction of the planar heating element 31) is less likely to be positioned in the normal position of the low thermal conductive member 21 in the same direction. However, since the planar heating element 31 is less likely to enter into the first recesses 22 or the second recesses 23 in the first embodiment, the length of the planar heating element 31 in the circumferential direction of the annular cross section CS is less likely to be shortened. Accordingly, the end portion of the planar heating element 31 in the circumferential direction can be easily positioned in the normal position of the low thermal conductive member 21 in the same direction.

(3) A portion of the outer peripheral surface of the low thermal conductive member 21 is configured by the convex surface portions 24, 25. In addition, the planar heating element 31 is attached to the low thermal conductive member 21 by being adhered to the outer peripheral surface of the low thermal conductive member 21 (FIG. 10).

Therefore, the planar heating element 31 is adhered to the outer peripheral surface of the low thermal conductive member 21 over a wide surface by the size of these convex surface portions 24, 25 whereby the adhering operation can be easily performed.

(4) A plurality of first recesses 22 is formed in such a way that the end portions 22A in the circumferential direction of the first arc-shaped cross section CS1 are arranged linearly and intermittently along near the sites where the diameter of the annular cross section CS is maximized.

Therefore, when an attaching operation of the planar heating element 31 is performed in a state where the rim cored bar 20 having the low thermal conductive member 21 is erected, positioning of the planar heating element 31 with respect to the low thermal conductive member 21 can performed in a simple operation of lowering the planar heating element 31 having the mark M attached thereto from the above of the attached portion and matching the mark M to the upper-side end portions 22A of each first recess 22.

(5) It is considered that the effects of the above-described (1) to (4) are obtained also by using the low thermal conductive member 21 that is divided into plural components. In this case, the plural components are pre-molded by a resin molding or the like, separately from the rim cored bar 20. Further, the plural components are respectively assembled to the rim cored bar 20 and then connected to each other. Void portions corresponding to the first recesses 22 and the second recesses 23 in the first embodiment are formed between the plural components and the rim cored bar 20. Similar to the first embodiment, the planar heating element 31 and the decorative member 35 are attached in sequence to the outside of the low thermal conductive member 21.

However, in this case, upon assembling the plural components to the rim cored bar 20, an operation of positioning the components with respect to the rim cored bar 20 is separately required. This operation may degrade the positional accuracy of the components relative to the rim cored bar 20.

Further, the operation of assembling the plural components to the rim cored bar 20 and connecting the plural components to each other may increase the cost of the steering wheel 12.

Furthermore, the void portions formed between the rim cored bar 20 and the plural components of the low thermal conductive member 21 may degrade the strength of the components.

In this regard, in the first embodiment, the low thermal conductive member 21 is formed integrally with the rim cored bar 20 by using the rim cored bar 20 as an insert and molding the low thermal conductive member 21 around the rim cored bar 20.

Therefore, an operation of assembling the components of the low thermal conductive member 21 to the rim cored bar 20 is not required, it is possible to increase the positional accuracy of the low thermal conductive member 21 relative to the rim cored bar 20 and, also, it is possible to suppress the increase in cost.

Further, in the first embodiment, the low thermal conductive member 21 is in close contact with the rim cored bar 20 and recesses for forming the void portion between the rim cored bar 20 and the low thermal conductive member 21 are not provided in the low thermal conductive member 21. Therefore, it is possible to increase the strength of the low thermal conductive member 21.

(6) Assuming that the irregular shape of the surface of the planar heating element 31 is embossed on an outer surface (design surface) of the rim part 13, the appearance quality of the rim part 13 and thus the steering wheel 12 is impaired.

In this regard, in the first embodiment, the decorative member 35 is formed of PP (Polypropylene) that is a rigid resin material. For this reason, the outer surface of the rim part 13 is less likely to be affected by the irregular shape of the planar heating element 31. Accordingly, the outer surface of the rim part 13 can be in a smooth or substantially smooth state, so that it is possible to suppress the degradation of the appearance performance of the rim part 13 due to the irregular shape of the planar heating element 31.

Further, since the decorative member 35 is rigid and less likely to be deformed, it is possible to suppress a phenomenon that the decorative member 35 is deformed in accordance with the irregular shape of the planar heating element 31 when using (steering, etc.) the steering wheel 12.

### Second Embodiment

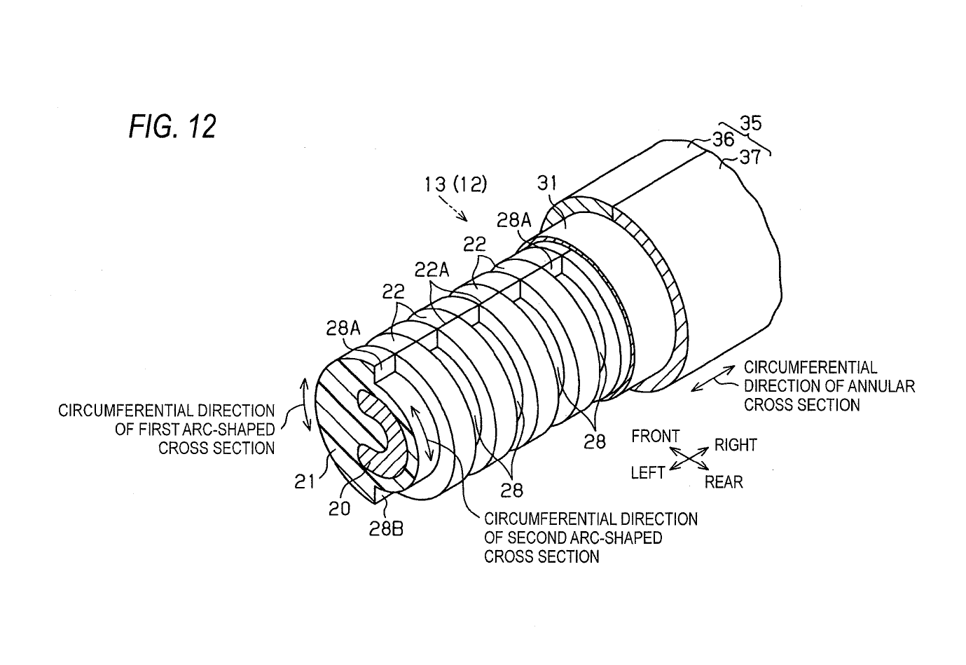

Next, a second embodiment embodying the present invention will be described with reference to FIG. 12 to FIG. 17.

The second embodiment is different from the first embodiment mainly in terms of the form of the second recesses of the low thermal conductive member 21. Next, the second embodiment will be described, focusing on the difference therebetween.

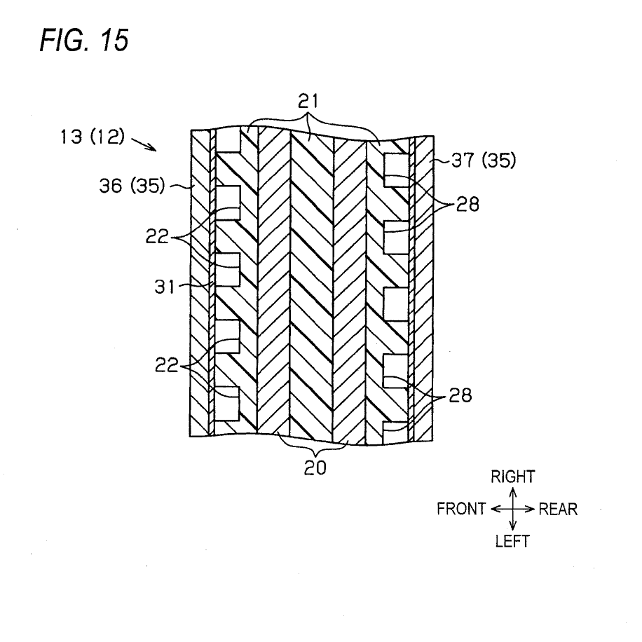

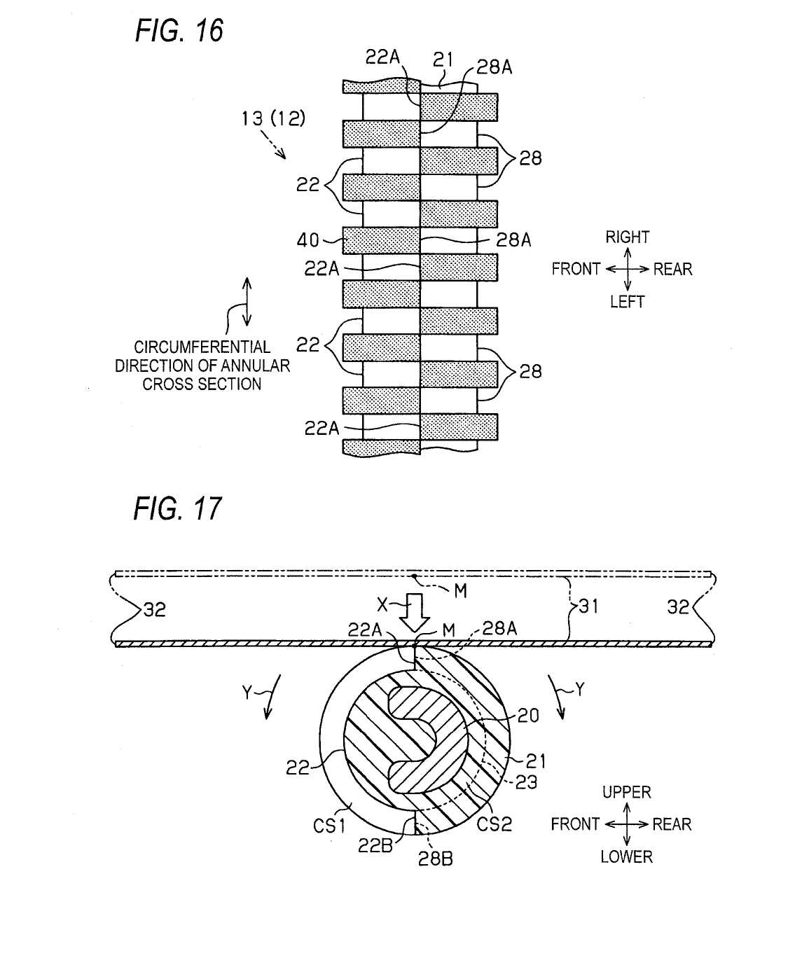

As shown in FIG. 12 to FIG. 14, second recesses 28 are provided in the sites that are located in a plane including the axis L1 and passing through between the first recesses 22 adjacent in the circumferential direction of the annular cross section CS and located on the opposite side of each first recess 22 across the rim cored bar 20. The second recesses 28 have the second arc-shaped cross section CS2 forming a semicircular arc shape. Each of the second recesses 28 is formed in such a way that one-side end portions 28A in the circumferential direction of the second arc-shaped cross section CS2 are continuously arranged collinear with the line on which the one-side end portions 22A of the first recesses 22 are arranged along the circumferential direction of the annular cross section CS (see FIG. 16) and the other-side end portions 28B in the circumferential direction are continuously arranged collinear with the line on which the other-side end portions 22B of the first recesses 22 are arranged along the circumferential direction of the annular cross section CS. The low thermal conductive member 21 has a shape in which the first recesses 22 and the second recesses 28 respectively forming a semicircular arc shape are arranged in a zigzag manner (alternately) in the circumferential direction of the annular cross section CS (see FIG. 15 and FIG. 16). Since these configurations are employed, the convex surface portions 24, 25 as described above are not formed in the low thermal conductive member 21 of the second embodiment.

Here, it is considered that the width and depth of the first recesses 22 in the second embodiment are the same as the width and depth of the first recesses 22 in the first embodiment and the width and depth of the second recesses 28 in the second embodiment are the same as the width and depth of the second recesses 23 in the first embodiment. Since the first recesses 22 and the second recesses 28 are disposed as described above, the occupying volume of the first recesses 22 and the second recesses 28 per unit volume of the low thermal conductive member 21 in the second embodiment is greater than the occupying volume thereof in the first embodiment. This means that the heat insulating effect exhibited by the air inside the first recesses 22 and the second recesses 28 in the second embodiment is greater than the heat insulating effect exhibited by the air inside the first recesses 22 and the second recesses 23 in the first embodiment.

A plurality of first recesses 22 is formed in such a way that the upper-side end portions 22A in the circumferential direction of the first arc-shaped cross section CS1 are arranged linearly along the site where the diameter of the annular cross section CS is maximized. Similarly, a plurality of second recesses 28 is formed in such a way that the upper-side end portions 28A in the circumferential direction of the second arc-shaped cross section CS2 are arranged linearly along the site where the diameter of the annular cross section CS is maximized.

Further, a plurality of first recesses 22 is formed in such a way that the lower-side end portions 22B in the circumferential direction of the first arc-shaped cross section CS1 are arranged linearly along the site where the diameter of the annular cross section CS is minimized. Similarly, a plurality of second recesses 22 is formed in such a way that the lower-side end portions 28B in the circumferential direction of the second arc-shaped cross section CS2 are arranged linearly along the site where the diameter of the annular cross section CS is minimized.
Other configurations are the same as in the first embodiment. Accordingly, the same or similar element will be denoted by the same reference numeral as that of the first embodiment and the duplicated explanation thereof will be omitted.

Next, an operation of the steering wheel 12 of the second embodiment configured as described above will be described.

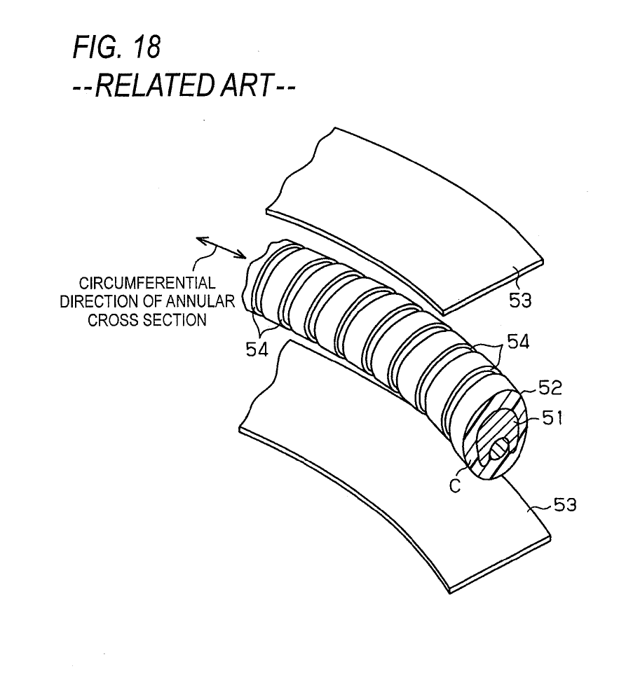

Initially, an operation of attaching the planar heating element 31 to the low thermal conductive member 21 will be described. Similarly to the first embodiment, this operation is performed in a state where the rim cored bar 20 including the low thermal conductive member 21 is erected (the axis L1 is horizontal) and the attached portions of the low thermal conductive member 21 to be attached with the planar heating element 31 are located on the top of the rim cored bar 20.
First, as indicated by the halftone in FIG. 16, on the attached portions of the low thermal conductive member 21 to be attached with the planar heating element 31, i.e., on the top of the rim cored bar 20 in the erected state, the adhesive (gluing agent) 40 is applied to an outer peripheral surface of the sites of the low thermal conductive member 21 on which the first recesses 22 and the second recesses 28 are not provided. Since the arranged sites of the second recesses 28 of the low thermal conductive member 21 are changed and the convex surface portions 24, 25 are not formed in the second embodiment, the adhesive (gluing agent) 40 is applied to an outer peripheral surface of the low thermal conductive member 21 that is different from the first embodiment. The sites to be applied with adhesive include an outer peripheral surface between the first recesses 22 adjacent in the circumferential direction of the annular cross section CS and an outer peripheral surface between the second recesses 28 adjacent in the circumferential direction. As described above, since the occupying volume of the first recesses 22 and the second recesses 28 per unit volume of the low thermal conductive member 21 in the second embodiment is greater than the occupying volume thereof in the first embodiment, the area of the sites to be applied with the adhesive (gluing agent) 40 is smaller than the area thereof in the first embodiment.
When the adhesive (or gluing agent) 40 is dried to some extent, the planar heating element 31 is adhered to the outer peripheral surfaces of the low thermal conductive member 21 while being deformed along the shape of the low thermal conductive member 21, as shown in FIG. 17.
In the second embodiment, the upper-side end portions 22A of each first recess 22 and the upper-side end portions 28A of each second recess 28 are continuously arranged on the top of the rim cored bar 20 in the erected state in such a way that these end portions 22A, 28A are located in the same line along the circumferential direction of the annular cross section CS. Therefore, a plurality of upper-side end portions 22A, 28A linearly arranged can be used as a reference when carrying out positioning on the circumferential direction of the first arc-shaped cross section CS1 and the second arc-shaped cross section CS2.

Therefore, upon attaching the planar heating element 31 to the low thermal conductive member 21, positioning of the planar heating element 31 relative to the low thermal conductive member 21 is carried out by using, as a reference, the end portions 22A, 28A linearly arranged as described above.

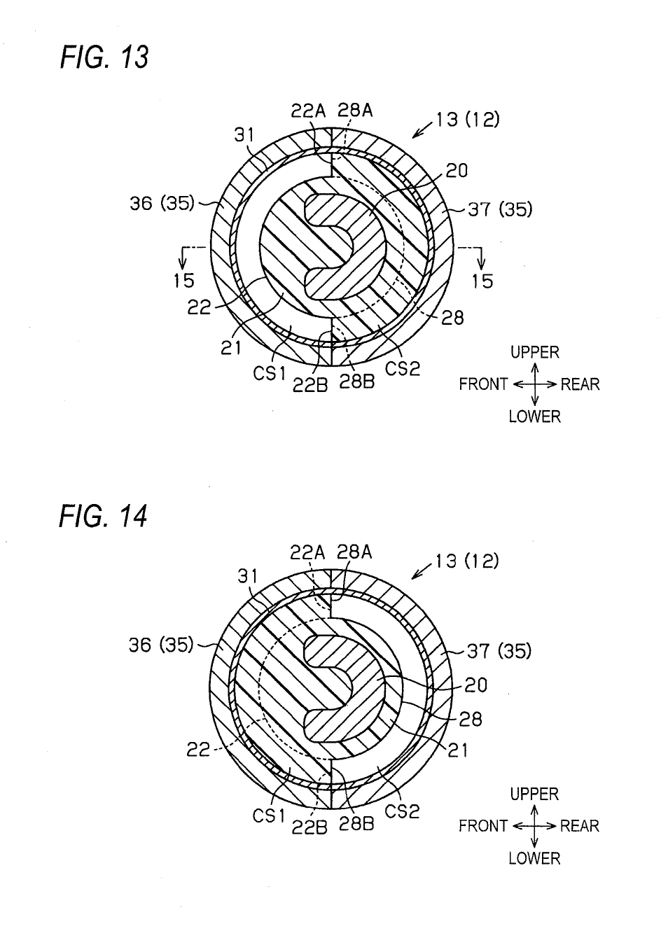

For example, in a case where the planar heating element 31 is disposed in the normal position of the low thermal conductive member 21, the sites of the planar heating element 31 which are located on the top of the rim cored bar 20 and correspond to the end portions 22A, 28A are set in advance. Then, the mark M is attached to the site of the planar heating element 31. In the second embodiment, the end portions 22A, 28A in the circumferential direction of the first arc-shaped cross section CS1 and the second arc-shaped cross section CS2 are located in the sites where the diameter of the annular cross section CS is maximized. For this reason, the mark M is attached to the substantially central portion in the width direction (lateral direction in FIG. 17) of the planar heating element 31.
As indicated by two-dot chain line in FIG. 17, the planar heating element 31 is placed on the top of the attached portions of the low thermal conductive member 21 so that the mark M is positioned on the top of the end portions 22A, 28A. In such a state, when the planar heating element 31 is lowered as indicated by an arrow X in FIG. 17 and therefore the mark M matches the end portions 22A, 28A as indicated by a solid line in FIG. 17, the planar heating element 31 is in a state of being positioned in the circumferential direction of the first arc-shaped cross section CS1 and the second arc-shaped cross section CS2. A portion of the planar heating element 31, i.e., the portion of the planar heating element 31 near the mark M is adhered, through the adhesive (gluing agent) 40, to near the site of the low thermal conductive member 21 where the diameter of the annular cross section CS is maximized.
Subsequently, the portions of the planar heating element 31 located on both sides of the marker M in the width direction thereof are respectively deformed downwardly along an outer peripheral surface of the low thermal conductive member 21, as indicated by an arrow Yin FIG. 17. In the course of this deformation, the planar heating element 31 is adhered to the outer peripheral surface between the first recesses 22 adjacent in the circumferential direction of the annular cross section CS and the outer peripheral surface between the second recesses 28 adjacent in the circumferential direction, out of the outer peripheral surface of the low thermal conductive member 21.
As shown in FIG. 13 and FIG. 14, eventually, both opposing edges 32 in the width direction of the planar heating element 31 are adhered to the lower-side end portions 22B of each first recess 22 and the lower-side end portions 28B of each second recess 28B.
In this way, the planar heating element 31 is disposed around the low thermal conductive member 21 so as to surround the low thermal conductive member 21. Accordingly, the planar heating element 31 is attached to the low thermal conductive member 21 in such a way that the planar heating element 31 is adhered to an outer peripheral surface of the low thermal conductive member 21 while being disposed in the normal position of the low thermal conductive member 21.
Next, an operation of the steering wheel 12 in which the planar heating element 31 is attached to the low thermal conductive member 21, as described above, will be described.

When the heating body (electric heating wire) of the planar heating element 31 shown in FIG. 12 and FIG. 15 generates heat by energization, the transfer of some of the heat toward the rim cored bar 20 is suppressed by the heat insulating effect of the air inside the first recesses 22 and the air inside the second recesses 28. As described above, since the occupying volume of the first recesses 22 and the second recesses 28 per unit volume of the low thermal conductive member 21 is increased, the transfer of the heat generated from the planar heating element 31 toward the rim cored bar 20 is further suppressed, as compared to the first embodiment. As a result, more of the heat generated from the planar heating element 31 is transferred to the decorative member 35 and therefore the decorative member 35 is heated more efficiently. Since the heat generated from the planar heating element 31 is efficiently transferred to the decorative member 35 even when the temperature of the outer surface of the rim part 13 is low, the decorative member 35 is heated, at an early stage, up to a temperature at which a driver can easily grip the decorative member.

As a result, according to the second embodiment, the following effects are obtained, in addition to the above effects (1) and (4) to (6).

(7) The second recesses 28 are provided in the sites that are located in a plane including the axis L1 and passing through between the first recesses 22 adjacent in the circumferential direction of the annular cross section CS and located on the opposite side of the first recess 22 across the rim cored bar 20. The second recesses 28 have the second arc-shaped cross section CS2 forming a semicircular arc shape. The second recesses 28 are formed in such a way that the end portions 28A in the circumferential direction of the second arc-shaped cross section CS2 are continuously arranged collinear with the line on which the end portions 22A of the first recesses 22 are arranged along the circumferential direction of the annular cross section CS (see FIG. 12 to FIG. 16).

Therefore, the phenomenon that the heat generated from the planar heating element 31 is transferred to the rim cored bar 20 through the low thermal conductive member 21 can be suppressed by the air inside the first recesses 22 and the air inside the second recesses 28. This effect of suppressing the heat transfer can be greater than when the second recesses 28 are not provided.
Further, since the total volume of the first recesses 22 and the second recesses 28 can be greater than that of the recesses in the first embodiment, the effect of suppressing the heat transfer can be enhanced than the first embodiment.

Further, the end portions 22A of the first recesses 22 in the circumferential direction of the first arc-shaped cross section CS1 and also the end portions 28A of the second recesses 28 in the circumferential direction of the second arc-shaped cross section CS2 are arranged on the same line. Therefore, upon attaching the planar heating element 31 to the low thermal conductive member 21, positioning of the planar heating element 31 relative to the low thermal conductive member 21 can be carried out by using, as a reference, the end portions 22A, 28A linearly arranged as described above.

The first and second embodiments may be realized as the following modifications.

<With Respect to Cross Section Shape of Rim Part 13>
The cross section of the rim part 13 in a plane including the axis L1 may have a non-circular shape, e.g., an elliptical shape.

### <With Respect to Material of Low Thermal Conductive Member 21>

The low thermal conductive member 21 may be formed of materials other than the PP (Polypropylene), e.g., a rigid urethane, as long as the materials have a thermal conductivity lower than the rim cored bar 20.

### <With Respect to First Recesses 22 and Second Recesses 23, 28>

In the first embodiment, one of the first recesses 22 and the second recesses 23 may be omitted. In this case, it is necessary that the other one of the first recesses 22 and the second recesses 23 is formed in such a way that the end portions thereof are arranged linearly and intermittently along the circumferential direction of the annular cross section CS.
The cross-sectional shape of the first recesses 22 and the second recesses 23, 28 in the annular cross section CS may be changed to the cross-sectional shape that is different from the first embodiment and the second embodiment.
The number of the first recesses 22 and the number of the second recesses 23, 28 in a plane including the axis L1 of the steering shaft 11 may be changed to the number that is different from the first embodiment and the second embodiment.
The first recesses 22 and the second recesses 23, 28 may be formed to have a depth and width (length in the circumferential direction of the annular cross section CS) that are different from the first embodiment and the second embodiment. By deepening the depth of the first recesses 22 and the second recesses 23, 28 and also widening the width thereof, the amount of air inside these recesses is increased and therefore it is possible to enhance the heat insulating effect.
A portion of each first recess 22 or some of a plurality of first recesses 22 may penetrate the low thermal conductive member 21 and face the rim cored bar 20. Similarly, a portion of each second recess 23, 28 or some of a plurality of second recesses 23, 28 may penetrate the low thermal conductive member 21 in a radial direction and face the rim cored bar 20.

A plurality of first recesses 22 may be formed in such a way that the end portions 22A in the circumferential direction of the first arc-shaped cross section CS1 are arranged linearly along the site that is different from the site or its vicinity where the diameter of the annular cross section CS is maximized. A plurality of second recesses 23, 28 may be formed in a similar way.
Further, a plurality of first recesses 22 may be formed in such a way that the end portions 22B in the circumferential direction of the first arc-shaped cross section CS1 are arranged linearly along the site that is different from the site or its vicinity where the diameter of the annular cross section CS is minimized. A plurality of second recesses 23, 28 may be formed in a similar way.

### <With Respect to Annular Cross Section CS, First Arc-Shaped Cross Section CS1 and Second Arc-shaped Cross Section CS2>

The annular cross section CS may have a shape other than the annular shape.
The first arc-shaped cross section CS1 and the second arc-shaped cross section CS2 may have a circular arc shape other than the semicircular arc shape or the substantially semicircular arc shape. For example, a circular arc shape having a peripheral length longer than the semicircular arc may be employed. Further, the first arc-shaped cross section CS1 and the second arc-shaped cross section CS2 may have an arc shape other than the circular arc shape.

<With Respect to Convex Surface Portions 24, 25>
The number of the convex surface portions 24, 25 in the circumferential direction of the first arc-shaped cross section CS1 and the second arc-shaped cross section CS2 may be changed to one or three or more. When the number of the convex surface portions 24, 25 is changed to one, it is desirable that the convex surface portions 24, 25 are provided in the site or its vicinity where the diameter of the annular cross section CS is maximized, in consideration of the workability of an operation of attaching the planar heating element 31 to the low thermal conductive member 21. In this case, it is assumed that the operation of attaching the planar heating element 31 to the low thermal conductive member 21 is performed in a state where the rim cored bar including the low thermal conductive member 21 is erected (the axis is horizontal) and the attached portions of the low thermal conductive member 21 to be attached with the planar heating element 31 are located on the top of the rim cored bar 20.
The length of the convex surface portions 24, 25 in the circumferential direction of the first arc-shaped cross section CS1 and the second arc-shaped cross section CS2 may be changed. As this length is increased, the area of the convex surface portions 24, 25 is increased and therefore the operation of attaching the planar heating element 31 to the low thermal conductive member 21 is easily performed. On the other hand, each volume of the first recesses 22 and the second recesses 23 is decreased and therefore the heat insulating effect of the air inside the first recesses 22 and the air inside the second recesses 23 is degraded. Accordingly, it is desirable that the length of the convex surface portions 24, 25 in the circumferential direction is determined, depending on whether improvement in the adhering workability of the planar heating element 31 or improvement in the heat insulating effect by air is prioritized.

<With Respect to Planar Heating Element 31>
In a case where the heating body of the planar heating element 31 generates heat by energization, a heating body other than the above-described electric heating wire may be used. For example, a heating body in which a resistive element layer is formed on an insulating sheet may be used.
The heating body of the planar heating element 31 may generate heat by using a means other than the energization. For example, the heating body may be made of chemical substances which store (absorb) heat in accordance with the dehydration and dissipate (generate) heat in accordance with the hydration.
The planar heating element 31 may be provided in the site in the circumferential direction of the annular cross section CS, which is different from the first and second embodiments. Further, the planar heating element 31 may be provided in multiple sites in the circumferential direction of the annular cross section CS. Furthermore, the planar heating element 31 may be provided over the entire periphery of the annular cross section CS.
The planar heating element 31 may be attached to the low thermal conductive member 21 in a manner other than the adhesion or attachment.
The planar heating element 31 that is divided into plural in the circumferential direction of the annular cross section CS may be used. Further, the planar heating element 31 that is divided into plural in the circumferential direction of the first arc-shaped cross section CS1 and the second arc-shaped cross section CS2 may be used.

<With Respect to Decorative Member 35>
The decorative member 35 may be formed of rigid materials other than wood, e.g., ceramics or the like.
In a case where the embossing of the outer shape of the planar heating element 31 is not very noticeable or some embossing is not a problem, the decorative member 35 formed of soft materials, e.g., leather may be used.

<Others>
The steering wheel 12 is not limited to a steering wheel of a vehicle but may be applied to a steering wheel of a steering system in other vehicular things such as an aircraft, vessel, etc. In this case, the vehicle is not limited to a private vehicle but includes various industrial vehicles.

Additionally, technical concepts that can be understood from each of the above-described embodiments are described together with effects thereof.

(A) In the steering wheel described in any one of the configurations [2] to [4], the plurality of first recesses are formed in such a way that the end portions in the circumferential direction of the first arc-shaped cross section are arranged linearly along the site or its vicinity where the diameter of the annular cross section is maximized.

The above configuration is effective when the operation of attaching the planar heating element to the low thermal conductive member is performed in a state where the rim cored bar including the low thermal conductive member is erected (the axis is horizontal) and the attached portions of the low thermal conductive member to be attached with the planar heating element are located on the top of the rim cored bar.

In this manner, in the steering wheel, the end portions of each first recess that are arranged linearly along the circumferential direction of the annular cross section and used as a reference when carrying out positioning on the circumferential direction of the first arc-shaped cross section are located on the top of the rim cored bar in the erected state.

Therefore, upon attaching the planar heating element to the low thermal conductive member, positioning of the planar heating element relative to the low thermal conductive member is carried out by using the end portions of each first recess as a reference. For example, in a case where the planar heating element is disposed in the normal position of the low thermal conductive member, the sites of the planar heating element which are located on the top of the rim cored bar and correspond to the end portions of the first recesses are set in advance. The planar heating element is placed on the top of the attached portions of the low thermal conductive member so that the sites are positioned on the top of the end portions of each first recess. In such a state, when the planar heating element is lowered and therefore the sites match the end portions of the first recesses, the planar heating element is in a state of being positioned in the circumferential direction of the first arc-shaped cross section. Further, the planar heating element is disposed around the low thermal conductive member so as to surround the low thermal conductive member whereby the planar heating element is disposed in the normal position of the low thermal conductive member.

(B) In the steering wheel described in any one of the configurations [2] to [4] and the above-described (A), the decorative member is formed of rigid materials.

In this case, assuming that the irregular shape of the planar heating element is embossed on an outer surface (design surface) of the rim part, the appearance quality of the rim part is impaired. However, since the decorative member provided around the planar heating element is formed of rigid materials, the outer surface of the rim part is less likely to be affected by the irregular shape of the planar heating element. Accordingly, the outer surface of the rim part can be in a smooth or substantially smooth state. As a result, it is possible to suppress the degradation of the appearance performance of the rim part due to the irregular shape of the planar heating element.

Further, the decorative member is rigid and less likely to be deformed. Therefore, the decorative member is less likely to be deformed in accordance with the irregular shape of the planar heating element when using the steering wheel.

What is claimed is:

1. A steering wheel comprising a rim part that has:
a rim cored bar that is a skeletal portion of the rim part;
a low thermal conductive member that is formed of a material having a thermal conductivity lower than the rim cored bar and covers the rim cored bar;
a planar heating element that is attached to the low thermal conductive member in a state of surrounding the low thermal conductive member; and
a decorative member that covers the planar heating element,
wherein the low thermal conductive member includes recesses which have an arc-shaped cross section forming an arc shape in a plane including an axis of the steering wheel and are formed in multiple sites that are spaced apart from each other in the circumferential direction of an annular cross section of the steering wheel in a plane perpendicular to the axis of the steering wheel, and
wherein the plurality of recesses are formed so that the end portions in the circumferential direction of the arc-shaped cross section are arranged linearly along the circumferential direction of the annular cross section.

2. The steering wheel according to claim 1, wherein the recesses are first recesses and the arc-shaped cross section is a first arc-shaped cross section,
wherein the low thermal conductive member further includes second recesses that are arranged to be opposed to the first recesses across the rim cored bar in the plane including the axis and has a second arc-shaped cross section forming an arc shape,
wherein the plurality of second recesses are formed so that the end portions in the circumferential direction of the second arc-shaped cross section are arranged linearly along the circumferential direction of the annular cross section, and
wherein convex surface portions are formed between adjacent end portions of the first recesses and the second recesses in the circumferential direction of the first arc-shaped cross section and the second arc-shaped cross section.

3. The steering wheel according to claim 2, wherein the convex surface portions form part of an outer peripheral surface of the low thermal conductive member, and
wherein the planar heating element is attached to the low thermal conductive member by being adhered to the outer peripheral surface of the low thermal conductive member.

4. The steering wheel according to claim 1, wherein the recesses are first recesses and the arc-shaped cross section is a first arc-shaped cross section,
wherein the low thermal conductive member further includes second recesses that are arranged to be opposed to the first recesses across the rim cored bar in a plane including the axis and passing through between the first recesses adjacent in the circumferential direction of the annular cross section and has a second arc-shaped cross section forming an arc shape, and
wherein the second recesses are formed so that the end portions in the circumferential direction of the second arc-shaped cross section are arranged collinear with the line on which the end portions of the first recesses are arranged along the circumferential direction of the annular cross section.

5. The steering wheel according to claim 2, wherein the plurality of first recesses are formed so that the end portions in the circumferential direction of the first arc-shaped cross section are arranged linearly along a site or its vicinity where a diameter of the annular cross section is maximized.

6. The steering wheel according to claim 4, wherein the plurality of first recesses are formed so that the end portions in the circumferential direction of the first arc-shaped cross section are arranged linearly along a site or its vicinity where a diameter of the annular cross section is maximized.

7. The steering wheel according to claim 1, wherein the decorative member is formed of a rigid material.
